(19) United States
(12) Patent Application Publication
(10) Pub. No.: US 2008/0066112 A1
(43) Pub. Date: Mar. 13, 2008

(54) METHOD FOR IMPLEMENTING ON-DEMAND PVR PEER-TO-PEER MEDIA SHARING WITH CONTENT RESTRAINT

(76) Inventors: Byron Lewis Bailey, Savage, MN (US); Robert Douglas Holt, Raleigh, NC (US); Jason Allan Nikolai, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/466,820

(22) Filed: Aug. 24, 2006

(51) Int. Cl. H04N 5/445; G06F 3/00; G06F 13/00; H04N 7/173

(52) U.S. Cl. 725/58; 725/61; 725/86

(57) ABSTRACT

On-demand personal video recorder (PVR) peer-to-peer media sharing with content restraint is enabled with location and subscription protection. PVRs are enabled to share shows with other PVRs in a common local area domain and having common subscription lineup services. A menu-based system on the PVR gives users the capability to enable and disable sharing from all down to a particular show level.

### FIELD OF THE INVENTION

The present invention relates generally to the data processing field, and more particularly, relates to a method, apparatus and computer program product for implementing on-demand personal video recorder (PVR) peer-to-peer media sharing with content restraint.

### DESCRIPTION OF THE RELATED ART

A personal video recorder (PVR), also called digital video recorder (DVR), is a consumer electronics device that records television shows to a hard disk in digital format. Since first introduced by TiVo® at the Consumer Electronics Show in 1999, PVRs have steadily developed complementary abilities, such as recording onto DVDs. This makes a time shifting feature traditionally done by a VCR, much more convenient, and also allows for trick modes, such as pausing live TV, instant replay of interesting scenes, and skipping advertising.

Many modern day PVRs can record from two media inputs during a single time slot. However, occasionally, a user may forget to record a show. Or, sometimes recordings get cancelled or deleted by the user. In addition, although recording two forms of media is sufficient most of the time, it is very possible that three shows a user would like to watch overlap. Current conventional PVR technology does not allow for users to go back and record shows that they forgot to record or to record three overlapping shows.

Digital rights management (DRM) is an umbrella term referring to any of several technologies used to enforce pre-defined policies controlling access to software, music, movies, or other digital data. In more technical terms, DRM handles the description, layering, analysis, valuation, trading and monitoring of the rights held over a digital work, and generally includes any such management.

### SUMMARY OF THE INVENTION

Principal aspects of the present invention are to provide a method, apparatus and computer program product for implementing on-demand personal video recorder (PVR) peer-to-peer media sharing with content restraint. Other important aspects of the present invention are to provide such method, apparatus and computer program product for implementing on-demand personal video recorder (PVR) peer-to-peer media sharing with content restraint substantially without negative effect and that overcome many of the disadvantages of prior art arrangements.

In brief, a method, apparatus and computer program product are provided for implementing on-demand personal video recorder (PVR) peer-to-peer media sharing with content restraint. Peer-to-peer media sharing is enabled with location and subscription protection. PVRs are enabled to share shows with other PVRs in a common local area domain and having common subscription lineup services. A menu-based system on the PVR gives users the capability to enable and disable sharing from all down to a particular show level.

In accordance with features of the invention, location and station lineup information within a peer-to-peer (P2P) PVR network is used to restrict the sharing of shows within a local domain and to share only the shows that a user would otherwise have access to record. This technology also can be applied to online radio broadcasting or any other form of broadcast media that has local market restrictions.

In accordance with features of the invention, users may query the peer-to-peer network for available shows, download the shows to a play list, and watch the shows either after enough of the show has been cached or after the show has been completely downloaded.

In accordance with features of the invention, bandwidth and other predefined restrictions can be implemented. With PVR Digital Rights Management based upon Location, Provider, and Lineup, many legal issues can be alleviated by only allowing PVRs to share shows with other PVRs in the local area domain who subscribe to the same local station lineup services.

In accordance with features of the invention, media searching or show searching may be accomplished using show name, where a show is defined as a named entity in a guide, that is a news show, movie, sports, or the like. Also media searching or show searching may be accomplished using station lineup and time. One use for station lineup and time occurs when recording a sporting event that was cut off at the end because it went past the time scheduled for the event. For example, when a user records a sporting event, and then watches the event to find that the event lasted five minutes longer than scheduled and the user misses the conclusion. If another user on the P2P PVR network had recorded the show scheduled directly after the sporting event, then the conclusion of the event is stored in that time slot.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B together illustrate a restricted peer-to-peer PVR network in accordance with the preferred embodiment;

FIG. 2 is a flow chart illustrating exemplary user level steps in accordance with the preferred embodiment;

FIG. 3 is a flow chart illustrating exemplary PVR to peer-to-peer server communication steps in accordance with the preferred embodiment; and

FIG. 4 is a block diagram illustrating a computer program product in accordance with the preferred embodiment.

### DETAILED DESCRIPTION OF THE PREFERRED EMBODIMENTS

In accordance with features of the preferred embodiments, methods are provided for implementing restricted peer-to-peer (P2P) media sharing with location and subscription protection. Typically there are numerous legal issues with P2P media sharing including regulations that prevent local advertisements from being broadcast nationally. The present invention alleviates many legal issues by only allowing PVRs to share shows with other PVRs in the local area domain who subscribe to the same local station lineup services. In other words, consider two users both having P2P PVRs, however, a first user subscribes to expanded cable service and a second user subscribes to basic cable service, the first user would be able to retrieve all of the shows on the second user's PVR, but the second user would only be able to retrieve shows from the first user's PVR that were recorded on basic cable, that the second user would otherwise have had access.

In accordance with features of the preferred embodiments, location information and station lineup information within a peer-to-peer (P2P) PVR network are used to restrict the sharing of shows within a local domain and to share only the shows that a user would otherwise have access to record.

It should be understood that this technology and methods in accordance with the present invention are not limited to video shows, and advantageously are applied to online radio broadcasting or any other form of broadcast media that has local market restrictions.

In accordance with features of the preferred embodiments, for example, through a menu-based system on the PVR, users have the capability to enable or disable sharing from all down to the show level. In addition, bandwidth and other restrictions advantageously are implemented. Users are able to query the P2P network for available shows, download the shows to their play list, such as a Now Playing List, and watch the shows either after enough of the show has been cached or after the show has been completely downloaded. Media searching is accomplished using new or existing search technologies.

For example, show searching could occur by show name, where a show is defined as a named entity in a guide, such as, a show includes a news show, movie, sports, and the like. Further, show searching could occur by station lineup/time. One use for station lineup/time would be for users who recorded a sporting event that was cut off at the end because it went past the time scheduled for the event. This frequently happens (a user records a sporting event, and comes back to watch it to find that the event when five minutes longer than scheduled and the user misses the conclusion). If another user on the P2P PVR network had recorded the show scheduled directly after the event, the conclusion of the event would be stored in that time slot. Also, show searching could occur by a recommender engine.

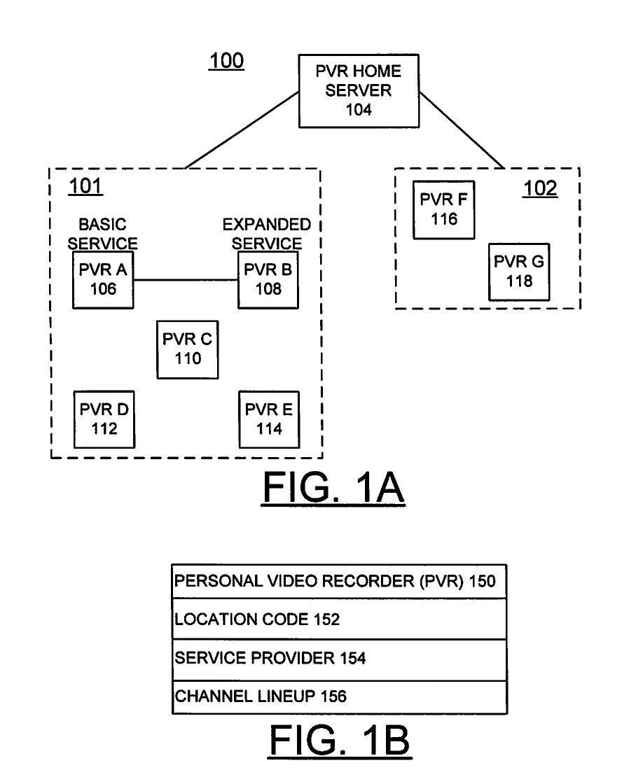

Having reference now to the drawings, in FIGS. 1A and 1B, an exemplary PVR network is shown in FIG. 1A generally designated by the reference character 1 00 in accordance with the preferred embodiment. An exemplary PVR 150 illustrated in FIG. 1B in accordance with the preferred embodiment.

PVR network 100 includes a first PVR domain 101 and a second PVR domain 102, each coupled to a PVR home server 104. The first PVR domain 101 includes a PVR A 106, PVR B 108, PVR C 110, PVR D 112, and PVR E 114. The second PVR domain 102 includes a PVR F 116, and PVR G 118.

As shown in FIG. 1B, each PVR 150 includes a location code 152, a service provider 154, and a channel lineup 156. PVRs are classified into PVR Domains 101, 102 according to a location code 152. Location code 152 provides an identifier based on geographical location and service provided in that location. In addition, the PVR 150 typically contains the service provider identifier 154. Most communities typically offer multiple options for television service; examples include: cable, satellite, antenna, and the like. Furthermore, the station lineup information 156, which is used by the PVR 150 to retrieve the appropriate guide information based on the services that are subscribed to, are used to restrict the content that PVRs could view/retrieve on other PVRs in accordance with the preferred embodiment.

In accordance with features of the preferred embodiments, the technology to implement the restricted peer-to-peer (P2P) media sharing methods with location and subscription protection is available today: PVR 150 contains variables, typically, but not necessarily stored in a database, while naming and implementation vary, but the concept is the same on all PVRs. PVRs typically contain location 152, such as zip code where the PVR resides; service provider 154, such as Charter Communications, DirecTV, and the like; guide and station lineup information 156, such as including the channels that the subscriber to the service receives; high speed Internet is ever increasingly available in households, peer-to-peer technology is stable and improving and the number of PVRs in use continues to grow.

In accordance with features of the preferred embodiments, the security is provided at the channel level with permission at a channel level in a lineup permits only a consumer who had the legal right to record the media in the first place to obtain the recorded media. This is similar to having multiple PVRs or VCRs in your house all recording different shows. Additional security at the implementation level may be provided to prevent unauthorized hacking of LINEUP information exchanged on the network. The existing Internet, a dialup network, and an existing or future network technology can implement the PVR network.

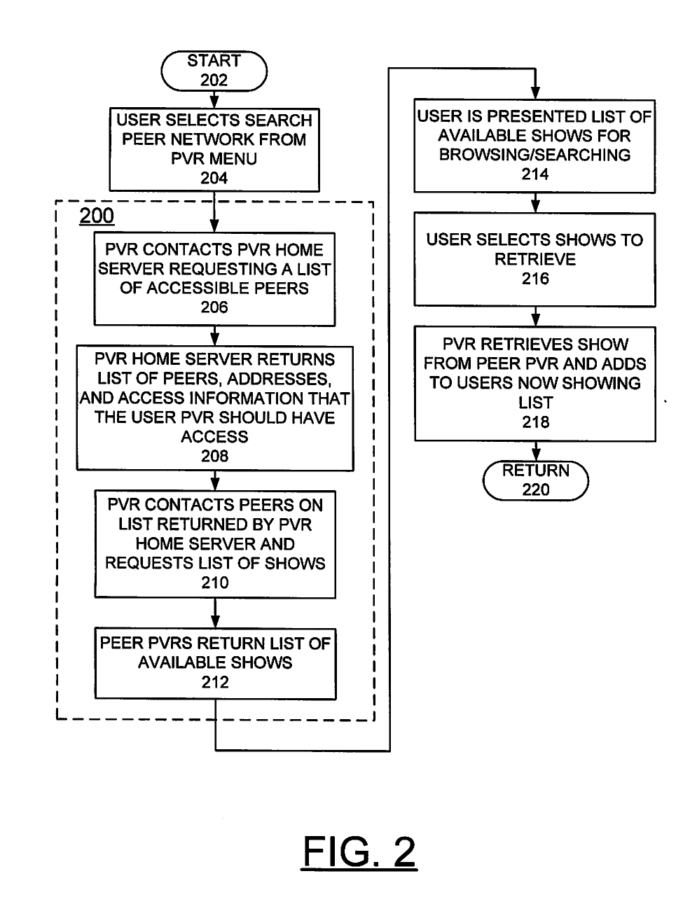

Referring now to FIG. 2, there is shown a flow chart illustrating exemplary user level steps in accordance with the preferred embodiment. A series of steps shown within dotted lines and generally designated by the reference character 200 depicts where the present invention fits into conventional P2P PVR technology in accordance with the preferred embodiment.

Exemplary user level operations start as indicated in a block 202. A user selects to search for shows available on P2P network as indicated in a block 204, for example, using a PVR menu. The particular PVR 150 of the user contacts the PVR Home server 104, which is the PVR service provider server, to obtain a list of accessible peers as indicated in a block 206. Next as indicated in a block 208, the PVR home server 104 returns a list of peers in the users PVR domain, such as domain 1 01 or domain 102 as shown in FIG. 1. The user's PVR contacts the peer PVRs, sends station lineup and service provider information as indicated in a block 210. Then the peer PVRs respond with a list of shows that are being shared and that the requesting user PVR has access as indicated in a block 212. The user can browse or search the returned list of available shows as indicated in a block 214. The user selects one or more shows to retrieve, as indicated in a block 216. The shows are retrieved and added to the Now Showing list on the user's PVR as indicated in a block 218 and the user can watch the show either after enough of the show has been cached or after the show has been completely downloaded. Then the user level operations return as indicated in a block 220.

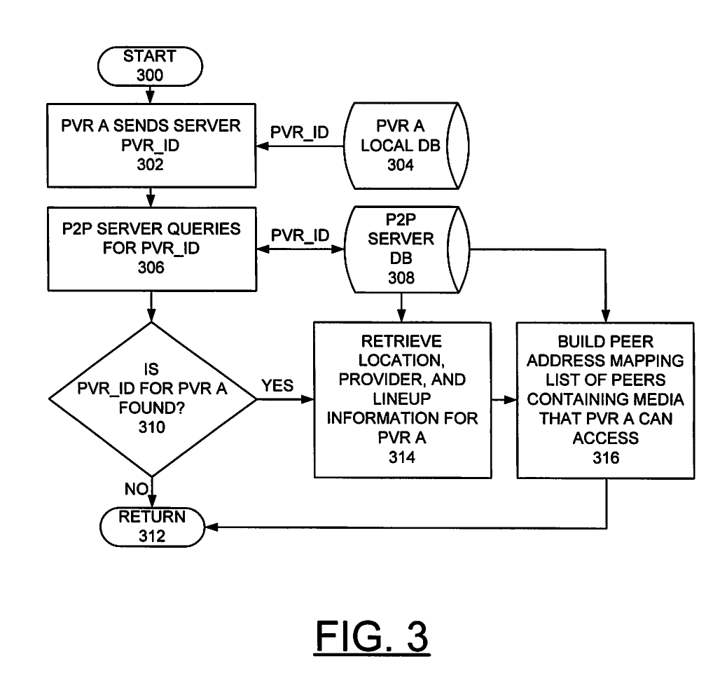

Referring now to FIG. 3, there is shown a flow chart illustrating exemplary PVR to peer-to-peer server communication steps in accordance with the preferred embodiment starting at a block 300. In FIG. 3, one possible implementation is shown of PVR Digital Rights Management based on Location, Provider, and Lineup in accordance with the preferred embodiment.

First as indicated in a block 302, PVR A connects to peer-to-peer (P2P) network and registers itself with server. A PVR_ID, which identifies the PVR, is sent to Peer-to-Peer (P2P) server, such as PVR home server 104, as indicated in a block 304. Next as indicated in a block 306, Peer-to-Peer (P2P) server queries for PVR_ID as indicated in a block 308. Checking whether PVR_ID for PVR is found is performed as indicated in a decision block 310. If PVR_ID is not found, null list of peers is returned as indicated in a block 312. If PVR_ID is found, based on PVR_ID, LOCATION, PROVIDER and LINEUP information are retrieved from database for PVR A as indicated in a block 314 and using LOCATION, PROVIDER and LINEUP data, a list of accessible channels by the PROVIDER is created for PVR A. Server compiles a list of PVRs on peer-to-peer network that contain all or a subset of the channel LINEUP which maps peer address to channel in the LINEUP, called the Lineup Peer Address Mapping List, as indicated in a block 316 and the operations return at block 31 2.

An example record in Lineup Peer Address Mapping List includes 1) ADDRESS: <Peer Address>; 2) PROVIDER: <Cable Basic>; and 3) LINEUP: <2,3,4,5,6,7,8,9, . . . >. The Lineup Peer Address Mapping List compiled at block 316 is sent to the PVR A. The PVR A builds a list of peers based on the Lineup Peer Address Mapping List returned by the server and the user is notified that peer network is available. The PVR A receives search criteria input from user and PVR A sends search request and available LINEUP to PVRs in Lineup Peer Address Mapping List.

An example search request sent to PVRs in Lineup Peer Address Mapping List includes 1) SEARCH CRITERIA: <Title=CSI>; 2) PROVIDER: <Cable Basic>; and 3) LINEUP: <2,8,12>. Peers respond to PVR A with results of search, in the above example, peers return shows meeting the search criteria Title=CSI that were recorded on channel 4, 8, or 12 where these are channels in PVR A's LINEUP. Then the user is returned the list of results from peer-to-peer network search and the user selects a show or shows to retrieve. Request to retrieve shows sent to peer on network, and then the peer on network sends requested show to PVR A. PVR A adds show to “Now Playing List” of shows, which allows the user to view the show.

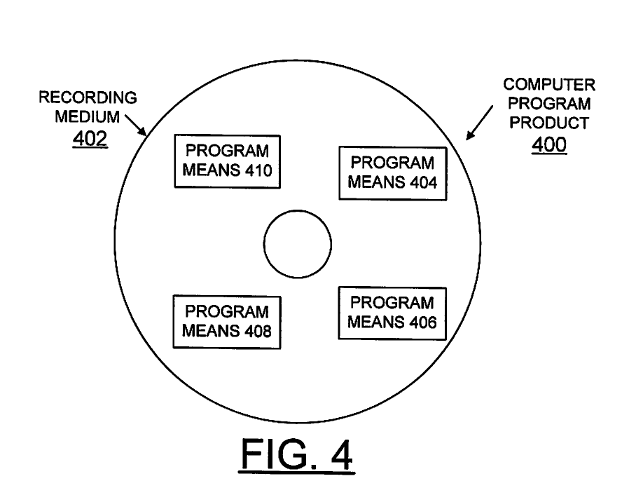

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing restricted peer-to-peer (P2P) media sharing with location and subscription protection of the preferred embodiment in the network system 100 of FIG. 1A.

A sequence of program instructions or a logical assembly of one or more interrelated modules defined by the recorded program means 404, 406, 408, 410, direct the PVR 150 and PVR home server 150 for implementing restricted peer-to-peer (P2P) media sharing with location and subscription protection of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing on-demand personal video recorder (PVR) peer-to-peer media sharing with content restraint comprising:
providing a peer-to-peer PVR network for media sharing with location and subscription protection; and
enabling each PVR in said peer-to-peer PVR network to share shows with other PVRs in a common local area domain and having common subscription lineup services.

2. A method for implementing on-demand personal video recorder (PVR) peer-to-peer media sharing with content restraint as recited in claim 1 includes providing a menu-based system on the PVR to allow users to enable and disable sharing from all down to a particular show level.

3. A method for implementing on-demand personal video recorder (PVR) peer-to-peer media sharing with content restraint as recited in claim 1 includes storing location, service provider and lineup information in each said PVR.

4. A method for implementing on-demand personal video recorder (PVR) peer-to-peer media sharing with content restraint as recited in claim 3 wherein enabling each PVR in said peer-to-peer PVR network to share shows includes using location and lineup information to restrict the sharing of shows with other PVRs in said common local area domain to share only shows that a user has access to record.

5. A method for implementing on-demand personal video recorder (PVR) peer-to-peer media sharing with content restraint as recited in claim 1 includes enabling users to query said peer-to-peer PVR network for available shows, downloading shows to a play list, and watching the shows.

6. A method for implementing on-demand personal video recorder (PVR) peer-to-peer media sharing with content restraint as recited in claim 1 includes providing a PVR server on said peer-to-peer PVR network; and one PVR on said peer-to-peer PVR network contacting said PVR server and requesting a list of accessible peers on said peer-to-peer PVR network.

7. A method for implementing on-demand personal video recorder (PVR) peer-to-peer media sharing with content restraint as recited in claim 6 includes said PVR server returning said list of accessible peers on said peer-to-peer PVR network to said one PVR.

8. A method for implementing on-demand personal video recorder (PVR) peer-to-peer media sharing with content restraint as recited in claim 7 includes said one PVR contacting said accessible peers on said peer-to-peer PVR network from said returned list and requesting a list of shows.

9. A method for implementing on-demand personal video recorder (PVR) peer-to-peer media sharing with content restraint as recited in claim 8 includes said one PVR retrieving a selected show from one of said accessible peers.

10. A method for implementing on-demand personal video recorder (PVR) peer-to-peer media sharing with content restraint as recited in claim 1 includes providing a PVR server coupled to said peer-to-peer PVR network; and one PVR on said peer-to-peer PVR network contacting said PVR server and providing an identification PVR_ID for said one PVR to said PVR server.

11. A method for implementing on-demand personal video recorder (PVR) peer-to-peer media sharing with content restraint as recited in claim 10 includes said PVR server building a lineup peer address mapping list; said lineup peer address mapping list including at least one peer address; a subscription service indication, and a lineup including available channels.

12. A method for implementing on-demand personal video recorder (PVR) peer-to-peer media sharing with content restraint as recited in claim 11 includes aid PVR server sending said lineup peer address mapping list to said one PVR.

13. Apparatus for implementing on-demand personal video recorder (PVR) peer-to-peer media sharing with content restraint comprising:
a peer-to-peer PVR network including a plurality of PVRs for media sharing with location and subscription protection; and
each said PVR in said peer-to-peer PVR network being enabled to share shows with other PVRs in a common local area domain and having common subscription lineup services.

14. Apparatus for implementing on-demand personal video recorder (PVR) peer-to-peer media sharing with content restraint as recited in claim 13 wherein each said PVR in said peer-to-peer PVR network include a menu-based system allowing users to enable and disable sharing from all shows to a particular show level.

15. Apparatus for implementing on-demand personal video recorder (PVR) peer-to-peer media sharing with content restraint as recited in claim 13 includes a PVR server coupled to said peer-to-peer PVR network; and wherein one PVR on said peer-to-peer PVR network contacts said PVR server and provides an identification PVR_ID for said one PVR to said PVR server.

16. Apparatus for implementing on-demand personal video recorder (PVR) peer-to-peer media sharing with content restraint as recited in claim 15 wherein said PVR server builds a lineup peer address mapping list and sends said lineup peer address mapping list to said one PVR; said lineup peer address mapping list including at least one peer address; a subscription service indication, and a lineup including available channels.

17. A computer program product for implementing on-demand personal video recorder (PVR) peer-to-peer media sharing with content restraint in a peer-to-peer PVR network including a plurality of PVRs and a PVR server, said computer program product including instructions executed by the PVRs to cause the PVRs to perform:
providing media sharing with location and subscription protection in the peer-to-peer PVR network; and
enabling each PVR in said peer-to-peer PVR network to share shows with other PVRs in a common local area domain and having common subscription lineup services.

18. A computer program product for implementing on-demand personal video recorder (PVR) peer-to-peer media sharing with content restraint as recited in claim 17 includes storing location, service provider and lineup information in each said PVR.

19. A computer program product for implementing on-demand personal video recorder (PVR) peer-to-peer media sharing with content restraint as recited in claim 17 includes one PVR on said peer-to-peer PVR network contacting the PVR server and requesting a list of accessible peers on said peer-to-peer PVR network.

20. A computer program product for implementing on-demand personal video recorder (PVR) peer-to-peer media sharing with content restraint as recited in claim 17 includes the PVR server building a lineup peer address mapping list and sending said lineup peer address mapping list to said one PVR; said lineup peer address mapping list including at least one peer address; a subscription service indication, and a lineup including available channels.
